(19) United States
(12) Patent Application Publication
(10) Pub. No.: US 2010/0285715 A1
(43) Pub. Date: Nov. 11, 2010

(54) METHOD OF MANUFACTURING CARBON NANOTUBE (CNT) FIELD EMISSION SOURCE

(76) Inventors: Yuan-Yao Li, Min-Hsiung (TW); Meng-Jey Youh, Linkou Shiang (TW); Chun-Lung Tseng, Alian Shiang (TW); Hung-Chih Wu, Jhonghe City (TW)

Correspondence Address: Muncy, Geissler, Olds & Lowe, PLLC, 4000 Legato Road, Suite 310, FAIRFAX, VA, 22033, US

(21) Appl. No.: 12/607,706

(22) Filed: Oct. 28, 2009

(30) Foreign Application Priority Data
May 8, 2009 (TW) 96115312

(51) Int. Cl. H01J 9/12

(52) U.S. Cl. 445/50; 977/742

(57) ABSTRACT

A method of manufacturing carbon nanotube (CNT) field emission source, comprising the following steps of: providing a substrate; disposing an electrode layer on substrate; applying a mixture on electrode layer by means of screen printing, and mixture is a mixture of CNT paste and carbon powder; performing sinter in proceeding with a heat cracking reaction, and the carbon cracked and obtained in a heat cracking reaction of carbon powder and polymer in CNT paste is used as a carbon source, and that is used to grow a CNT emission layer of a hedgehog-shaped CNT cluster structure, thus obtaining a cathode plate after completion of sinter process. The hedgehog-shaped CNT cluster structure is a carbon nanotube (CNT) emission layer capable of having multi-direction electron emission routes. As such, it can realize the characteristics of high current density, and low turn-on voltage, while raising the stability of electron field emission.

### BACKGROUND OF THE INVENTION

1. Field of the Invention

The present invention relates to a method of manufacturing a carbon nanotube (CNT) field emission source, and in particular to a carbon nanotube field emission capable of having multi-direction electron emission routes.

2. The Prior Arts

Since the invention and advent of carbon nanotube (CNT) in 1990's, it has caught the attention of the industry, due to its nano-meter size and fairly large surface area, special cylindrical tube structure formed by hexagonal carbon atom dot matrix, and its unique electrical, magnetic, optical characteristics, and various application potentials. Usually, a carbon nanotube (CNT) is characterized by its extremely small radius of curvature, extremely small size, hollowness in shape, high chemical stability, and high mechanical strength, as such it can be utilized in various applications, such as, field emission source, room-temperature transistors, and vehicles for hydrogen storage, etc. In particular, high aspect ratio and high chemical stability of CNTs make them excellent and very promising electron field emission source. Due to the superior electron field emission characteristics of CNTs, so that high current density can be induced by an electric field generated at relatively low voltage, thus it has become the best material for cathode emission source of field electrons.

Presently, there are two different ways of manufacturing carbon nanotube (CNT) cathode structure. Wherein, one method is to form carbon nanotube directly on a glass substrate by utilizing chemical vapor deposition (CVD). A disadvantage of this method is that its formation temperature is higher than the substrate softening temperature, in addition, its application to displayer of larger area is also limited; while another method is to print carbon nanotube (CNT) paste directly on a substrate by means of screen-printing. Compared with CVD method, the advantage of screen-printing method is that, not only low production cost and simplified manufacturing process can be achieved, but it can also be produced through large area printing. However, upon screen printing CNT paste on a substrate, in a process of high temperature sinter, the CNT will react with organic vehicle in the CNT paste, thus resulting in rather high loss of mass, and degrading the emission stability of CNT. In addition, for the structure made by means of screen printing, the direction of the emission thus produced is not aligned, hereby requiring further activation. In general, this is realized through pulling a flat carbon nanotube to be perpendicular to a substrate by making use of adhesive tape. However, in this way, the chemical residues of a tape remaining on a cathode structure tend to incur secondary contamination, in addition, direct contact of carbon nanotube with adhesive tape may also cause damage to its structure, thus adversely affecting the stability and service life of a field emission.

For the reasons mentioned above, it is evident that the structure, functions, and performances of conventional carbon nanotube of the prior art are still not quite satisfactory, thus it has much room for improvements.

### SUMMARY OF THE INVENTION

In view of the shortcomings and drawbacks of the prior art, the present invention discloses a carbon nanotube, so as to solve the afore-mentioned problems of the prior art.

A major objective of the present invention is to provide a method of manufacturing carbon nanotube field emission source, such that the subsequent activation steps can be eliminated, hereby simplifying the carbon nanotube field emission source manufacturing process and reducing the production cost.

Another objective of the present invention is to provide a method of manufacturing carbon nanotube field emission, that can be proceeded in a lower temperature without having to add an additional gas of hydrocarbon, so as to reduce hazards occurred during production.

A yet another objective of the present invention is to provide a method of manufacturing carbon nanotube (CNT) field emission, that is applicable to a field emission displayer or a high efficiency light emitting device.

To achieve the afore-mentioned objective, the present invention provides a method of manufacturing carbon nanotube field emission source, comprising the following steps: providing a substrate; disposing an electrode layer on the substrate; providing a mixture, formed by mixing a CNT paste with a carbon powder; and applying the mixture on the electrode layer by means of screen printing, then performing sinter in executing a heat cracking reaction to form a carbon nanotube (CNT) emission layer of a hedgehog-shaped CNT cluster structure.

In addition, the carbon nanotube (CNT) field emission source produced by the method of the present invention is applicable to a field emission displayer or a high efficiency light emitting device. In this respect, the fabrication of a field emission displayer is taken as an example for explanation. Therefore, upon obtaining a cathode plate according to the steps mentioned above, a field emission displayer can be assembled by means of a method, comprising the following steps of: providing a cathode plate, with its upper surface provided with an electrode layer thereon, and on the electrode layer is disposed with a carbon nanotube (CNT) emission layer of a hedgehog-shaped CNT cluster structure; disposing a spacer on the cathode plate; providing an anode plate on a top edge of the spacer, so that the spacer is located between the cathode plate and the anode plate; and putting the cathode plate, spacer, and anode plate into a vacuum chamber body, in proceeding with further packaging of the cathode plate, spacer, and anode plate, thus realizing the field emission displayer of the present invention.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a flow chart of the steps of a method of manufacturing carbon nanotube (CNT) field emission source according to an embodiment of the present invention;

FIG. 2 is a cross section view of a structure of a cathode plate manufactured by utilizing a method of manufacturing carbon nanotube field emission according to an embodiment of the present invention;

FIG. 3 is an image of a hedgehog-shaped CNT cluster structure observed through a scanning electronic microscope (SEM) according to an embodiment of the present invention;

FIG. 4 is another image of a hedgehog-shaped CNT cluster structure observed through a scanning electronic microscope (SEM) according to an embodiment of the present invention;

FIG. 5 is a cross section view of a structure obtained through applying a carbon nanotube (CNT) field emission into a field emission displayer according to an embodiment of the present invention; and

FIG. 6 is a schematic diagram of a field emission displayer under test according to an embodiment of the present invention.

### DETAILED DESCRIPTION OF THE PREFERRED EMBODIMENT

The purpose, construction, features, functions, and advantages of the present invention can be appreciated and understood more thoroughly through the following detailed description with reference to the attached drawings.

In the following, please refer to the related drawings together with detailed descriptions in describing a carbon nanotube (CNT) field emission source according to an embodiment of the present invention. For easy reference and understanding, similar reference numerals are utilized to refer to similar elements.

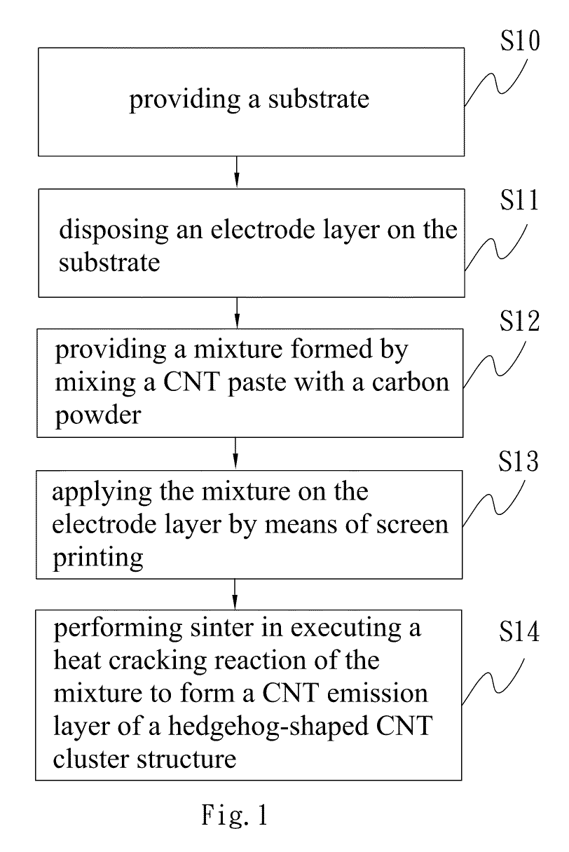

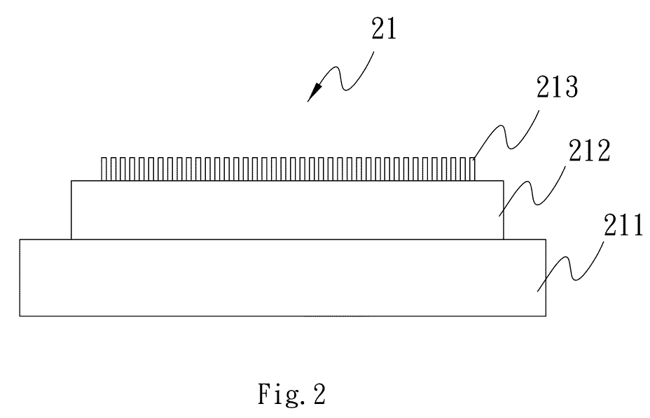

Refer to FIG. 1 for a flow chart of the steps of a method of manufacturing carbon nanotube (CNT) field emission source according to an embodiment of the present invention. Meanwhile, refer to FIG. 2 for a cross section view of a structure of a cathode plate manufactured by utilizing a method of manufacturing carbon nanotube field emission according to an embodiment of the present invention. As shown in FIG. 1, the method of manufacturing a CNT field emission source includes the following steps:

Step S10: providing a substrate 211, that can be a glass substrate, a plastic substrate, a ceramic substrate, or a silicon substrate.

Step S11: disposing an electrode layer 212 on the substrate 211, wherein, the manufacturing process of the electrode layer 212 includes the following steps of: applying a photosensitive conductive paste on a surface of the substrate 211, forming a pattern by means of a photolithographic process, then obtaining the electrode layer 212 after sintering. Wherein, the photolithographic process includes: defining patterns utilizing photo-mask after pre-baking, and then performing exposure and developing.

Step S12: providing a mixture of CNT paste and carbon powder, wherein, the mixture is formed by mixing CNT paste with carbon powder evenly by making use of a three-roll mills device. Wherein, the CNT paste includes: multi-wall CNT (MWCNT); organic vehicle, such as terpineol or EC; binder, such as frits, conductive powder, and dispersant, such as Triton X-100. The carbon powder selected to be used in the present invention can be obtained from a reclaimed carbon-powder cartridge, such that the carbon powder includes magnetic particles, polymers, and black carbon elements. In high temperatures, polymer of carbon powder will be cracked into carbon atoms, iron, cobalt, and nickel particles, hereby reacting to form a carbon nanotube.

Step S13: applying the mixture on the electrode layer 212 by means of screen printing.

Step S14: performing sinter, so that the mixture will undergo heat cracking reactions to form a CNT emission layer 213 of a hedgehog-shaped CNT cluster structure.

In the descriptions mentioned above, during step S14, the mixture undergoes heat cracking reactions through heat-up steps of a plurality of stages performed at various different constant heat-up temperatures, then the temperature is reduced to room temperature. Then, the sinter step includes the following actions: performing heat-up of the mixture, so that its temperature increases to a first stage heat-up temperature and stays there for a period of time, hereby enabling polymer to perform first stage de-hydrogenation in removing unnecessary volatile products. In the present invention, the first stage heat-up constant temperature is preferably between 300˜350° C., and the temperature rising speed from room temperature to the first stage heat-up constant temperature is preferably at 2˜5° C. per minute. Upon completing the heat-up of the mixture at a heat-up temperature of the first stage, then the temperature is raised to a heat-up temperature of the second stage and stays there for a period of time, so that polymer undergoes heat cracking reactions of the second stage. At this time, the carbon produced in the heat cracking reactions for carbon powder and polymer of CNT paste will be used as carbon source, and that is used to grow a CNT emission layer 213 of a hedgehog-shaped CNT cluster structure. Therefore, the hazard of prior art in producing CNT field emission source can be reduced, since no additionally added hydrocarbon gas is required. In the present invention, the second stage heat-up constant temperature is preferably between 350˜500° C., and the temperature rising speed from room temperature to the second stage heat-up constant temperature is preferably at 2˜5° C. per minute.

Since the cracking temperature of carbon powder is lower, so that when performing cracking reactions utilizing carbon powder and MWCNT of CNT paste, the possibility of MWCNT being oxidized is reduced, while carbon cluster material favorable to field emission effect can be produced. The characteristics of the carbon cluster material thus produced is that one surface of the hedgehog-shaped carbon cluster structure is always facing the anode. Therefore, some of the subsequent surface processing steps can be eliminated, thus resolving the shortcomings of the complexity of existing equipment and cathode structure activation procedure. In other words, the field emission characteristic of high current density can be achieved. In addition, the advantages of shortening manufacturing process, production time, and reducing production cost can be realized, so that it can be effectively used in producing field emission flat displayer or high efficiency light emitting device by making use of large area production process.

Moreover, in order to obtain much more production yield of hedgehog-shaped nanometer carbon cluster structure, the mixture may undergo another process of heat cracking reactions, that includes a gas infusion step of: in the heat cracking reaction, before the temperature rises to a first stage heat-up constant temperature, infusing in air before infusing in nitrogen gas, wait until temperature in the reaction room rises to a second stage heat-up constant temperature, then infusing in nitrogen gas to replace the air put in earlier. In this way, according to the production steps mentioned above, such that in a sinter step, the combination of gas, temperature, and the mixture are used to facilitate and promote growth of CNT. As such, in addition to being capable of protecting the original CNT from being damaged, meanwhile, a CNT emission layer 213 of a hedgehog-shaped CNT cluster structure can be produced, so that upon finishing the sinter step, a cathode plate 21 is obtained.

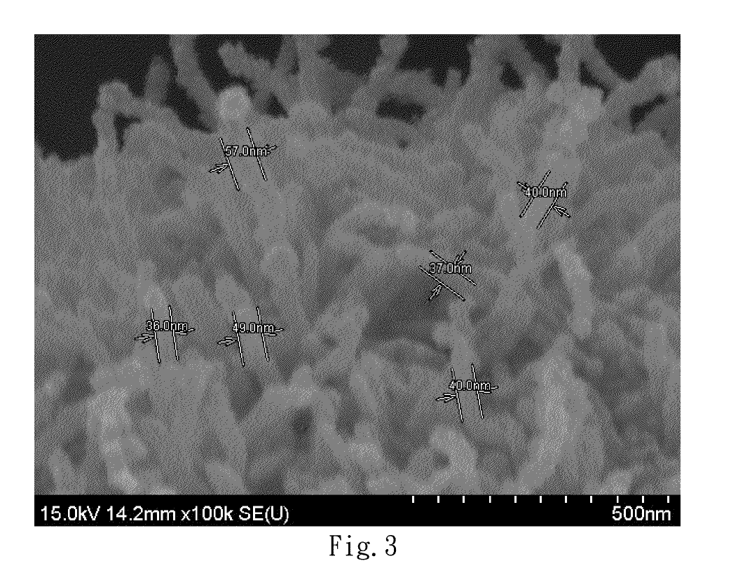

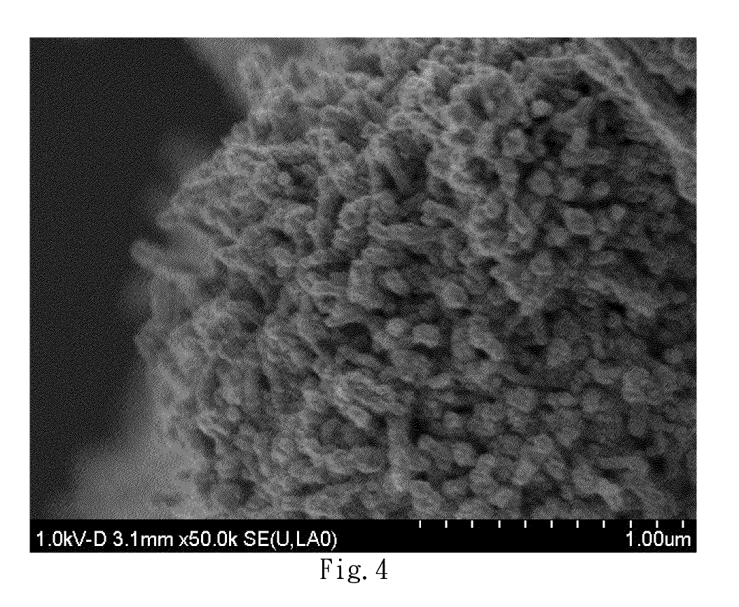

Refer to FIG. 3 and FIG. 4 for an image of a hedgehog-shaped CNT cluster structure observed through a scanning electronic microscope (SEM) according to an embodiment of the present invention, and another image of a hedgehog-shaped CNT cluster structure observed utilizing a scanning electronic microscope (SEM) according to an embodiment of the present invention respectively. As shown in FIG. 3 and FIG. 4, upon obtaining the product through subjecting the mixture to sinter process in proceeding with heat cracking reactions, a scanning electronic microscope (SEM) is used to observe an image of a hedgehog-shaped CNT cluster structure produced according to a method of the present invention. Since a carbon nanotube is capable of emitting electrons in all directions in a hedgehog shape, therefore, the hedgehog-shaped CNT cluster structure produced according to the present invention is a kind of CNT emission layer capable of having multi-direction electron emission routes, so that the characteristics of high current density, low turn-on voltage can be achieved without having to go through activation step.

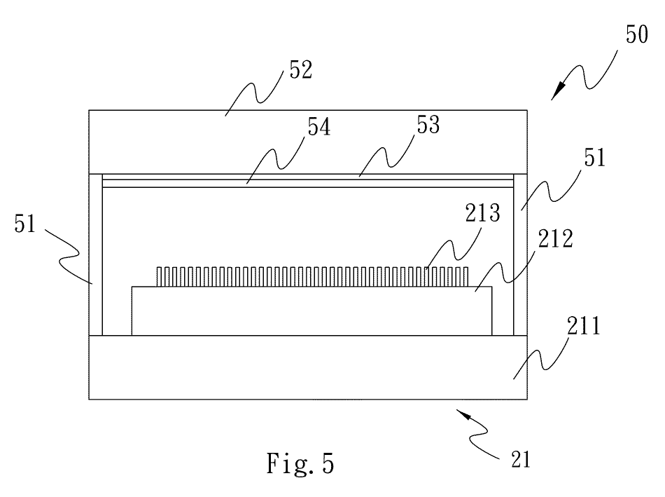

The CNT field emission source of the present invention can be applicable to a field emission displayer or a high efficiency light emitting device. In this embodiment, the application to a field emission displayer is taken as an example for explanation. Upon obtaining a cathode plate 21 produced according to a flow chart of the steps of a method of manufacturing carbon nanotube (CNT) field emission source as shown in FIG. 1, a field emission displayer 50 as shown in FIG. 5 can be assembled as follows: providing a substrate 211, with its upper surface provided with an electrode layer to serve as a cathode layer 212, and on the cathode layer 212 is provided with a CNT emission layer 213 of a hedgehog-shaped CNT cluster structure; then, disposing a plurality of spacers 51 on the cathode plate 21, and an anode plate 52 is disposed on a top edge of the spacer 51, so that spacer 51 is located between a cathode plate 21 and an anode plate 52. The anode plate 52 is made of a transparent conductive glass (ITO-glass). Wherein, the lower surface of the anode plate 52 is provided with transparent conductive layer to serve as an anode layer 53, the anode layer 53 is located correspondingly to a cathode plate 21, and a layer of phosphor 54 is screen printed on the anode layer 53. The phosphor 54 can be designed into the following two types based on the requirement of circuit design: the first type relates to the separately installed phosphor powders of three original colors red, green, and blue (abbreviated as RGB); and the second type relates to forming RGB three original colors simultaneously on a single phosphor 54.

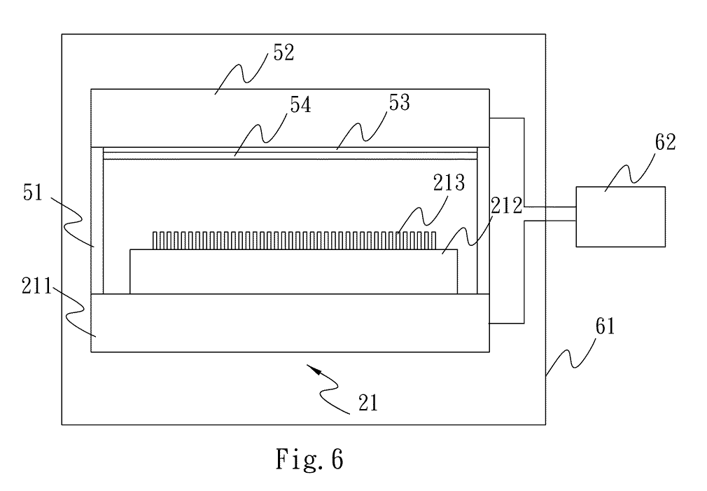

Finally, refer to FIG. 5 and FIG. 6 simultaneously. Wherein, FIG. 6 is a schematic diagram of a field emission displayer under test according to an embodiment of the present invention. As shown in FIG. 6, a cathode plate 21, a spacer 51, and an anode plate 52 are placed into a vacuum chamber body 61, wherein, the pressure of chamber body can be reduced below 10-5 Torr through utilizing a pump, as such proceeding with further packaging of cathode plate 21, spacer 52, and anode plate 53 in realizing a field emission displayer 50. In the present invention, a voltage supply device 62 (for example, it is capable of providing up to a maximum of 1100V) is used to provide voltage difference between cathode plate 21 and anode plate 52, so as to accelerate the electrons emitted from CNT emission layer 213 on cathode plate 21 in multi directions into impact onto a phosphor 54 of an anode plate 52, hereby agitating phosphor 54 into emitting visible lights.

The above detailed description of the preferred embodiments is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A method of manufacturing carbon nanotube (CNT) field emission source, that is applicable to a field emission displayer or high efficiency light emitting device, comprising the following steps:
providing a substrate;
disposing an electrode layer on said substrate;
providing a mixture, composed of a carbon nanotube paste and carbon powder; and
applying said mixture on said electrode layer by means of screen printing, performing sinter in proceeding with heat cracking reactions, hereby forming a CNT emission layer of a hedgehog-shaped CNT cluster structure.

2. The method of manufacturing carbon nanotube (CNT) field emission source as claimed in claim 1, wherein said mixture undergoes heat cracking reactions through heat-up steps of a plurality of stages performed at various different constant heat-up temperatures, then the temperature is reduced to a room temperature.

3. The method of manufacturing carbon nanotube (CNT) field emission source as claimed in claim 2, wherein said heat-up steps of said plurality of stages include at least a first stage of heat-up constant temperature at between 300˜350° C., and a second stage of heat-up constant temperature at between 350˜500° C.

4. The method of manufacturing carbon nanotube (CNT) field emission source as claimed in claim 3, wherein a temperature rising speed from room temperature to said first stage heat-up constant temperature is preferably at 2˜5° C. per minute.

5. The method of manufacturing carbon nanotube (CNT) field emission source as claimed in claim 3, wherein said temperature rising speed from room temperature to said second stage heat-up constant temperature is preferably at 2˜5° C. per minute.

6. The method of manufacturing carbon nanotube (CNT) field emission source as claimed in claim 1, wherein a step of said mixture undergoing said heat cracking reaction further includes a gas infusion step.

7. The method of manufacturing carbon nanotube (CNT) field emission source as claimed in claim 6, wherein said gas is nitrogen gas.

8. The method of manufacturing carbon nanotube (CNT) field emission source as claimed in claim 7, wherein said gas infusion step is performed as follows: firstly infusing in air before temperature rises to said first stage heat-up constant temperature, waiting until said temperature increases to said second stage heat-up constant temperature, then infusing in said nitrogen gas.

9. The method of manufacturing carbon nanotube (CNT) field emission source as claimed in claim 1, wherein said substrate is a glass substrate, a plastic substrate, a ceramic substrate, or a silicon substrate.

10. The method of manufacturing carbon nanotube (CNT) field emission source as claimed in claim 1, wherein said carbon nanotube (CNT) paste includes: multi-wall CNT (MWCNT), organic vehicle, binder, conductive powder, and dispersant.

11. The method of manufacturing carbon nanotube (CNT) field emission source as claimed in claim 1, wherein said carbon powder includes: magnetic particles, polymers, and black carbon elements.

12. The method of manufacturing carbon nanotube (CNT) field emission source as claimed in claim 1, wherein said mixture is formed by evenly mixing said CNT paste with said carbon powder by means of a three-roll mills device.

13. The method of manufacturing carbon nanotube (CNT) field emission source as claimed in claim 1, wherein a carbon obtained in a heat cracking reactions of said carbon powder and said polymer in said CNT paste is utilized as a carbon source, and that is used to grow said hedgehog-shaped CNT cluster structure.

14. The method of manufacturing carbon nanotube (CNT) field emission source as claimed in claim 1, wherein said hedgehog-shaped CNT cluster structure is a carbon nanotube (CNT) emission layer capable of having multi-direction electron emission routes.
